(19) United States
(12) Patent Application Publication
(10) Pub. No.: US 2015/0288677 A1
(43) Pub. Date: Oct. 8, 2015

(54) SYSTEM FOR PROVIDING CUSTOMIZED TELEMATICS SERVICES

(71) Applicant: HYUNDAI MOTOR COMPANY, Seoul (KR)

(72) Inventor: Chang Woo Chun, Anyang (KR)

(21) Appl. No.: 14/463,184

(22) Filed: Aug. 19, 2014

(30) Foreign Application Priority Data
Apr. 4, 2014 (KR) 10-2014-0040424

(51) Int. Cl. H04L 29/06

(52) U.S. Cl. CPC H04L 63/083; H04L 63/12

(57) ABSTRACT

A telematics terminal of a system for providing customized telematics services includes: a terminal communicator configured to receive information required for authentication from a master terminal or a slave terminal. In particular, a controller is configured to activate a server communicator by receiving an authentication request through the terminal communicator and then transmit the information required for authentication to a telematics server to perform the authentication. The server communicator is then configured to be activated by the controller to communicate with the telematics server.

### CROSS-REFERENCE TO RELATED APPLICATION

This application is based on and claims the benefit of priority to Korean Patent Application No. 10-2014-0040424, filed on Apr. 4, 2014 in the Korean Intellectual Property Office, the disclosure of which is incorporated herein in its entirety by reference.

### TECHNICAL FIELD

The present disclosure relates to a system for providing customized telematics services, and more particularly, to a technology of allowing a master user (administrator) to set a use right for each telematics service to each slave user and providing the telematics services to a normally authenticated slave user.

### BACKGROUND

The word telematics is a compound word of telecommunication and informatics that refers to a wireless data service which can communicate information with an information processing apparatus embedded in transportation equipment such as a vehicle, an airplane, a ship, etc. by a wireless communication technology, a global positioning system (GPS), a technology of changing a character signal and a voice signal on the Internet, and the like.

In particular, the telematics services combine a mobile communication technology and a positioning technology with a vehicle to provide vehicular accidents, theft detection, a driving route guide, traffic and life information, game, and the like to a driver in real time.

Further, when a vehicle has broken down while driving, the telematics services for a vehicle may access a service center in wireless communication, receive e-mail through a display device installed in front of a driver's seat or provide road information. Alternatively, the system may be used to provide computer applications or games through a display device installed at a back seat of a vehicle for passengers. In addition, since a controller connected to an engine of a vehicle records a state of main components of the vehicle, the system can remotely troubleshoot the failure of the vehicle via communication with an auto mechanic at any time of day.

The telematics services for a vehicle are subscribed/opened in a vehicle unit, have different kinds of services which may be provided according to a cost system. Thus, the system is often a paid service. Therefore, when an entire family commonly uses one vehicle and when a number of drivers commonly use one vehicle such as in a taxi cab, a method of providing customized telematics services for each user is required. Currently there is no such system that allows for this customized use.

### SUMMARY

The present disclosure has been made to solve the above-mentioned problems occurring in the prior art while advantages achieved by the prior art are maintained intact

An aspect of the present disclosure provides a system for providing customized telematics services capable of providing user customized telematics services by allowing a master user (administrator) to set a use right for each telematics service to each slave user and providing the telematics services to a non-administrator authenticated slave user.

The foregoing and other objects, features, aspects and advantages of the present disclosure will be understood and become more apparent from the following detailed description of the present disclosure. Also, it can be easily understood that the objects and advantages of the present disclosure can be realized by the units and combinations thereof recited in the claims.

According to an exemplary embodiment of the present disclosure, a telematics terminal of a system for providing customized telematics services includes: a terminal communicator configured to receive information required for authentication from a master terminal or a slave terminal; a controller configured to activate a server communicator by receiving an authentication request through the terminal communicator and then transmit the information required for authentication to a telematics server to perform the authentication; and the server communicator configured to be activated by the controller to communicate with the telematics server.

According to another exemplary embodiment of the present disclosure, a telematics server of a system for providing customized telematics services includes: a communicator configured to communicate with a master terminal and a telematics terminal; a controller configured to store a set user authentication information table from the master terminal in a storage device and perform authentication based on the user authentication information table; and the storage device configured to store the user authentication information table under the control of the controller.

According to still another exemplary embodiment of the present disclosure, a system for providing a customized telematics service includes: a telematics terminal configured to store a user authentication information table (hereinafter, first table) received from a telematics server, transmit information required for authentication received along with an authentication request from a master terminal or a slave terminal to the telematics server to make the authentication, and directly perform the authentication based on the first table when not communicating with the telematics server; and the telematics server configured to store the set user authentication information (hereinafter, second table) from the master terminal and perform the authentication based on the second table.

### BRIEF DESCRIPTION OF THE DRAWINGS

The above and other objects, features and advantages of the present disclosure will be more apparent from the following detailed description taken in conjunction with the accompanying drawings.

FIG. 1 is a configuration diagram of a system for providing customized telematics services according to an exemplary embodiment of the present disclosure;

FIG. 2 is a configuration diagram of a telematics terminal according to an exemplary embodiment of the present disclosure; and

FIG. 3 is a configuration diagram of a telematics server according to an exemplary embodiment of the present disclosure.

### DETAILED DESCRIPTION

The foregoing objects, features and advantages will become more apparent from the following description of exemplary embodiments of the present disclosure with reference to accompanying drawings, which are set forth hereinafter. Accordingly, those having ordinary knowledge in the related art to which the present disclosure pertains will easily embody technical ideas or spirit of the present disclosure. Further, when technical configurations known in the related art are considered to make the contents obscure in the present disclosure, the detailed description thereof will be omitted. Hereinafter, exemplary embodiments of the present disclosure will be described in detail with reference to the accompanying drawings.

It is understood that the tern) “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles, fuel cell vehicles, and other alternative fuel vehicles (e.g. fuels derived from resources other than petroleum).

Additionally, it is understood that the below methods are executed by at least one controller. The term controller refers to a hardware device that includes a memory and a processor configured to execute one or more steps that should be interpreted as its algorithmic structure. The memory is configured to store algorithmic steps and the processor is specifically configured to execute said algorithmic steps to perform one or more processes which are described further below.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

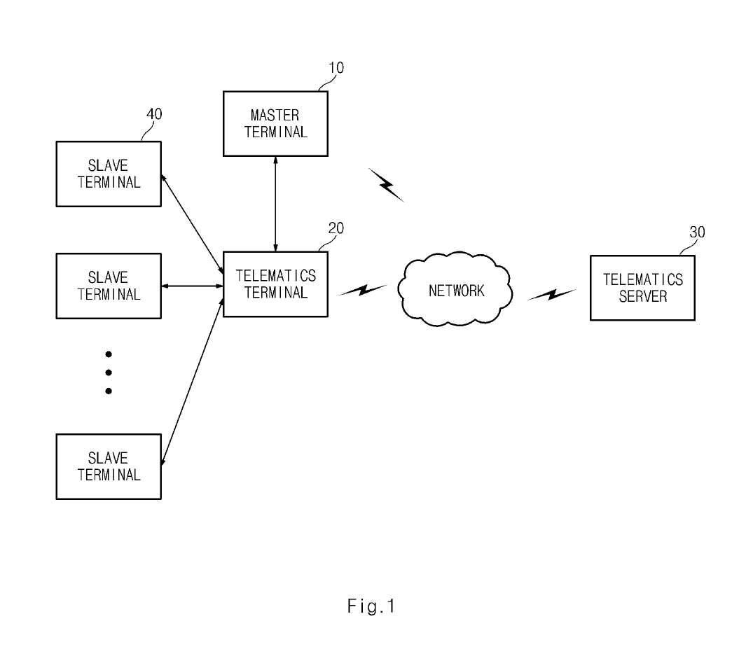

FIG. 1 is a configuration diagram of a system for providing customized telematics services according to an exemplary embodiment of the present disclosure. As illustrated in FIG. 1, the system for providing customized telematics services according to the exemplary embodiment of the present disclosure includes a master terminal 10, a telematics terminal 20, a telematics server 30, and at least one slave terminal 40.

Describing each component, the master terminal 10 is a portable terminal (for example, smart phone) of a vehicle owner or a user exerting authority for a vehicle and is configured to access the telematics server 30 through networks (e.g., a mobile communication network, a local area network, and the like) to set a use right of telematics services for each slave user who is received from the master user.

That is, a user authentication information table generated by making the master user access the telematics server 30 through the master terminal 10 is as provided in the following Table 1.

TABLE 1

| Key | Value | Type |
|---|---|---|
| Master user ID | MasterUser | String |
| Master user PW | ******** | String |
| Master user Email | master@hyundai.com | String |
| Master user telephone | 010-0000-0001 | String |
| Service name | [Gen1, Gen2, Gen3] | Enum List |
| Vehicle | [TESTHDZT000000001, | String List |
| Identification number | TESTHDZT000000002 | |
| | TESTHDZT000000003 | |
| Terminal number | [000000000001, | String List |
| | 000000000002, | |
| | 000000000003] | |
| Rate system information | Gen2_All_IN_ONE | Enum |
| Driver authentication/ | . . . | Driver_Info List |
| Setting information | | |

In the above Table 1, the driver authentication/setting information is as the following Table 2. Therefore, the master terminal 10 may conveniently set the use right for the telematics services for each slave terminal 40 based on a telephone number.

TABLE 2

| Telephone number | Name | Priority | Set vehicle/service use |
|---|---|---|---|
| 010-0000-0001 | MasterUser | 1 | Service list information |
| 010-0000-0002 | User#1 | 2 | Service list information |
| . . . | . . . | . . . | . . . |

In the above Table 2, the service list information is as the following Table 3.

TABLE 3

| Service | | | |
|---|---|---|---|
| ID | Service name | Set value | Remarks |
| 0-0-001 | Start vehicle | O | Select |
| 0-0-002 | Open and close | X | Select |
| | trunk | | |
| 2-0-001 | CAN | O | Required TMS |
| 2-0-002 | SOS | O | Required TMS |
| 2-1-001 | Remotely start | O | Rate system O |
| 2-1-002 | Remotely open/ | O | Rate system O |
| | Close door | | |
| 2-1-003 | Locate vehicle | O | Rate system O |
| 2-2-001 | Automatic diagnosis | X | Rate system O |
| 2-2-002 | Driving information | X | Rate system O |
| 2-3-001 | Local search | O | Rate system O |
| 2-3-002 | Send2Car POI | X | Rate system O |
| 2-4-001 | Geo Fence | O, house-100 km, | Rate system O |
| | | [Harlem_1, Harlem_2] | |
| 2-4-002 | Curfew Alert | O, 22:00~06:00 | Rate system O |
| 2-5-001 | DownLoad App | O | Rate system O |
| 2-5-002 | Streaming Service | X | Rate system X |
| . . . | . . . | . . . | . . . |

In the above Table 3, the service list includes a starting service of a vehicle, a movable area restricting service of a vehicle, and a driving time restricting service of a vehicle.

The master terminal 10 accesses the telematics server 30 to store applications for setting authority for telematics services for each slave terminal 40.

Further, the master terminal 10 may communicate with the telematics terminal 20 in a wired/wireless manner. That is, the master terminal 10 can transmit information required for authentication to the telematics terminal 20 and receive and display the authenticated result from the telematics terminal 20. Next, the telematics terminal 20 accesses the telematics server 30 through the networks (mobile communication network, local area network, and the like) to request the authentication of the master terminal 10 or the slave terminal 40 and receive the authenticated result.

Further, the telematics terminal 20 receives and stores the user authentication information table from the telematics server 30. In this case, the update of the user authentication information table stored in the telematics terminal 20 is made when t the vehicle is turned on or there is an update request from the telematics server 30. Once the user authentication information table is updated, it is preferable to transmit only the updated information, not the entire information. However, when the telematics terminal 20 is not configured to store the user authentication information table, it is preferable to provide the entire information.

When the telematics terminal 20 does not properly communicate with the telematics server 30 due to, for example, the poor network state when the master terminal 10 or the slave terminal 20 are authenticated, a authentication process itself may be performed based on the prestored user authentication information table.

Next, the telematics server 30 may also store the user authentication information table set by the master terminal 10, perform the authentication based on the user authentication information table according to the authentication request from the telematics terminal 20, and provide the telematics service permitted to the normally authenticated slave terminal 40.

Further, in the case in which the user authentication information table is changed, when the telematics server 30 starts to communicate with the telematics terminal 20, the telematics server 30 requests the update of the user authentication information table.

Next, the slave terminal 40 may be a portable terminal (for example, smart phone) owned by the user other than the master user and that is configured to communicate with the telematics terminal 20 in a wired/wireless manner to transmit the information required for authentication. This slave terminal 40 may also be configured to display the authenticated result.

Once authentication is completed, the slave terminal 40 may receive only the telematics service set by the master terminal 10. In addition, to receive the telematics services, the authority allocation of the master user needs to be first performed.

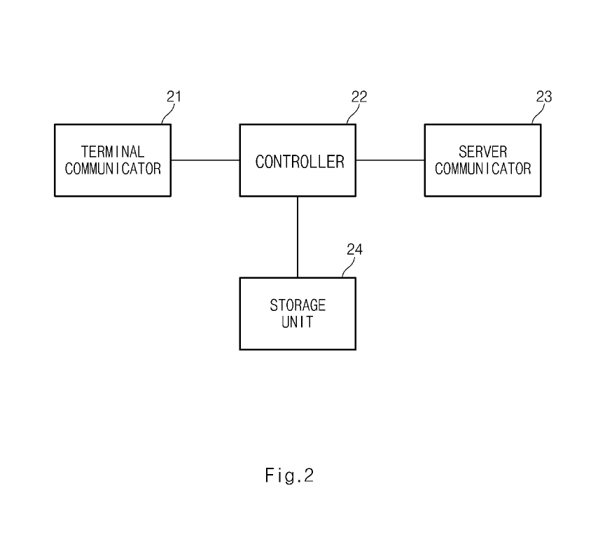

FIG. 2 is a configuration diagram of the telematics terminal according to the exemplary embodiment of the present disclosure. As illustrated in FIG. 2, the telematics terminal according to the exemplary embodiment of the present disclosure includes a terminal communicator 21, a controller 22, a server communicator 23, and a storage unit 24.

Describing each component, the terminal communicator 21 communicates with the master terminal 10 or the slave terminal 40 to receive the information required for authentication (e.g., a telephone number, name, and the like). Further, the terminal communicator 21 provides the telematics service permitted by the master terminal 10 to the normally authenticated master terminal 10 or slave terminal 40 under the control of the controller 22.

Next, the controller 22 controls each component to normally perform all the functions. In particular, the controller 22 may be configured to activate the server communicator 23 according to the authentication request from the master terminal 10 or the slave terminal 40 through the terminal communicator 21. Once the server communicator 23 is activated, the controller 22 can transmit the information required for authentication received through the terminal communicator 21 to the telematics server 30 and receive the authenticated result from the telematics server 30. In this case, the controller 22 can transmit the authenticated result to the corresponding terminal through the terminal communicator 21.

Further, when the authentication is made, the controller 22 provides the telematics services from the telematics server 30 to the user. Next, the storage unit (or device, such a special purpose memory or hard drive) 24 is an additional element of the present disclosure and stores the user authentication information table received from the telematics server 30 under the control of the controller 22.

In this case, when the controller 22 does not properly communicate with the telematics server 30 due to the poor network state, the controller 22 itself may perform the authentication process based on the user authentication information table stored in the storage unit 24. Further, the controller 22 updates the user authentication information table stored in the storage unit 24 when the vehicle is turned on or there is an update request from the telematics server 30.

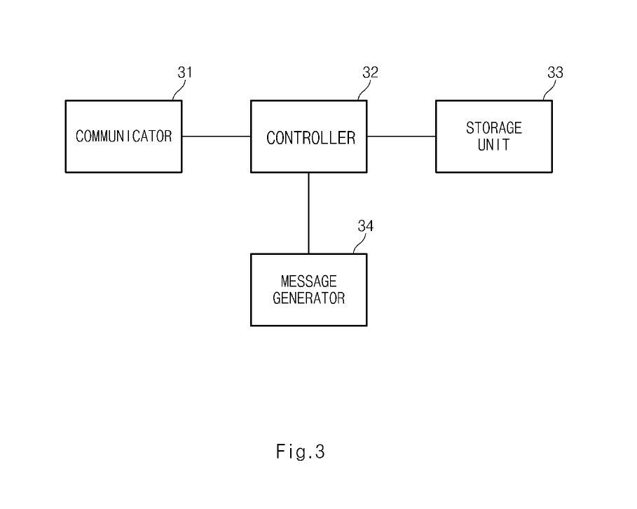

FIG. 3 is a configuration diagram of a telematics server according to an exemplary embodiment of the present disclosure. As illustrated in FIG. 3, the telematics server according to the exemplary embodiment of the present disclosure includes a communicator 31, a controller 32, a storage unit 33, and a message generator 34.

Describing each component, the communicator 31 performs communication with the master terminal 10 and the telematics terminal 20. That is, the communicator 31 receives the set user authentication information table from the master terminal 10 under the control of the controller 32 and stores the set table in the storage unit 33.

Further, the communicator 31 provides various kinds of telematics services to the corresponding telematics terminal 20. Next, the controller 32 controls each component to normally perform their respective function. In particular, the controller 32 stores the set user authentication information table in the storage unit 33 through the communicator 31.

When the controller 32 receives an authentication request through the communicator 31, the controller 32 performs the authentication based on the user authentication information table which is stored in the storage unit 33. In this case, once the authentication is made, the controller 32 provides the corresponding telematics service and when the authentication is not normally made, activates the message generator 34. The activated message generator 34 then generates a message notifying an illegal use and then transmits the generated message to the master terminal 10 through the communicator 31.

According to the exemplary embodiments of the present disclosure, the telematics services may also include a notification service (for example, automatic collision notification service) which is provided from a telematics center to a number of users (e.g., mobile phones) associated with a vehicle.

As described above, according to the exemplary embodiments of the present disclosure, it is possible to provide the user customized telematics services by allowing the master user to set the use right for each telematics service to each slave user and providing the telematics services to the normally authenticated slave user.

Further, according to the exemplary embodiments of the present disclosure, even when the user has the smart key, the holder of the smart key can still be prevented by the master from starting the vehicle until the master user provides the use permission to the user, and therefore it is possible to prevent a vehicle theft due to the loss of the smart key.

In addition, according to the exemplary embodiments of the present disclosure, it is possible to prevent children from driving a vehicle out of the defined area or late at night without their parent's permission by restricting the driving of the vehicle for each user according to the area and time.

The present disclosure described above may be variously substituted, altered, and modified by those skilled in the art to which the present disclosure pertains without departing from the scope and sprit of the present disclosure. Therefore, the present disclosure is not limited to the above-mentioned exemplary embodiments and the accompanying drawings.

What is claimed is:

1. A telematics terminal of a system for providing customized telematics services, comprising:
a first communicator configured to receive information required for authentication from a master terminal or a slave terminal;
a controller configured to activate a second communicator by receiving an authentication request from the first communicator and then transmit the information required for authentication to a telematics server so as to perform the authentication; and
the second communicator configured to be activated by the controller to communicate with the telematics server.

2. The telematics terminal according to claim 1, further comprising:
a storage device configured to store a user authentication information table received from the telematics server.

3. The telematics terminal according to claim 2, wherein the controller directly performs an authentication process based on the user authentication information table when the telematics server does not respond to the authentication request.

4. The telematics terminal according to claim 2, wherein the controller accesses the telematics server when s a vehicle is turned on to update the user authentication information table.

5. The telematics terminal according to claim 2, wherein the controller updates the user authentication information table according to an update request from the telematics server.

6. The telematics terminal according to claim 2, wherein the user authentication information table includes at least one of a starting service of a vehicle, a movable area restricting service of a vehicle, and a driving time restricting service of a vehicle as a kind of the telematics services.

7. A telematics server of a system for providing customized telematics services, the telematics server comprising:
a communicator configured to communicate with a master terminal and a telematics terminal;
a controller configured to store a set user authentication information table from the master terminal in a storage device for telematics services and perform authentication based on the user authentication information table; and
the storage device configured to store the user authentication information table under the control of the controller.

8. The telematics server according to claim 7, further comprising:
a message generator configured to generate a message notifying a user of an illegal use.

9. The telematics server according to claim 8, wherein the controller activates the message generator when the authentication is not completed to transmit the message to the master terminal.

10. A system for providing a customized telematics service, the system comprising:
a telematics terminal configured to store a first table received from a telematics server, transmit information required for authentication received along with an authentication request from a master terminal or a slave terminal to the telematics server to complete the authentication, and directly perform the authentication based on the first table when the telematics server is not able to be communicated with; and
the telematics server configured to store a second table from the master terminal and perform the authentication based on the second table.

11. The system according to claim 10, wherein the first table and the second table include at least one of a starting service of a vehicle, a movable area restricting service of a vehicle, and a driving time restricting service of a vehicle as a kind of the telematics services.

12. The system according to claim 10, wherein the telematics server transmits a message information notifying an illegal use to the master terminal when the authentication using the second table is not normally made.
